(19) United States
(12) Patent Application Publication
(10) Pub. No.: US 2005/0243647 A1
(43) Pub. Date: Nov. 3, 2005

(54) Aerosol mixing system with columns

(75) Inventors: Richard Gray, New York, NY (US); Christopher Mears, Chester, NJ (US); Joel Wittkamp, Morrisville, NC (US)

Correspondence Address: VENABLE LLP, P.O. BOX 34385, WASHINGTON, DC, 20045-9998, US

(73) Assignee: Mixtek System, LLC, NEW York, NY (US)

(21) Appl. No.: 10/521,437

(22) PCT Filed: Jul. 16, 2003
(86) PCT No.: PCT/US03/22282

§ 371 Date: Jan. 14, 2005

Related U.S. Application Data
(60) Provisional application No. 60/396,024, filed on Jul. 16, 2002.

(51) Int. Cl. B67D 5/60; B01F 5/06

(52) U.S. Cl. 366/336; 222/145.5

(57) ABSTRACT

A mixing system and methods for mixing a plurality of constituents from a plurality of containers that includes a collar (30), a head (10), a cartridge (20) and, optionally a base (40). If present, the base is configured to hold and secure at least two containers (50). The collar is configured for coupling to the containers (50). A head (10) is coupled to the collar (20) and contains the cartridge (20). The cartridge includes a plenum (22), a mixing canal (24), and an outlet (23), that are connected to mix the constituents as they pass through the plenum, mixing canal and outlet and are released from the container. The mixing canal (24) includes a plurality of columns (26), which may be of any shape, to facilitate mixing. The system can also include a leaver (29) for activating release of the constituents from the containers (50).

### FIELD OF INVENTION

This invention relates to a system for mixing the outputs of a plurality of containers in a convenient, hand-held device. Specifically, the invention employs a modular housing suitable for production through injection molding, with at least two components including a mixing chamber contained integrally within a cartridge. The mixing system is modular and has elements that are disposable after use.

Prior International Application Nos. PCT/US99/18738, filed Aug. 18, 1999, and PCT/US01/21007, filed Jul. 2, 2001, incorporated herein by reference, teach embodiments of the mixing system known commercially as the MIXTEK dispensing system. The latter application describes a mixing chamber comprising opposed alternating fins mounted from the sides of the mixing chamber.

### SUMMARY OF THE INVENTION

According to the present invention, an improved housing and baffle system are provided. In this improvement, a plurality of containers are securely held together to ensure simultaneous release of the ingredients therein and thorough mixing of the ingredients using a mixing chamber/baffle chamber with columns. The construction is simple and economical.

The invention provides an attractive, pressurized mixing technology that generally employs a dispensing head with an integral baffle chamber that fits onto at least two pressurized sources of mixable products. Upon actuation of the system by depressing the head or a lever attached to the head, the ingredients in both containers are metered and mixed together in a controllable dosage in the baffle chamber and are then released through the dispensing head. A primary advantage is that the ingredients are metered, mixed, and released and the user never has to touch the product. The separation of the products is maintained until release from the containers. This is an advantage for ingredients that must be separated until the moment of use, including hair coloring products, hair relaxers, epoxides and resins, and the like. The system is designed to work with state-of-the-art container technology including but not limited to barrier packs and all forms of aerosol compartments that contain aerosol within an enclosed pressurized space. The innovative dispensing head/tip and cartridge can be used with either a single can or multi-can application. The entire unit may be encased in a contour-fitting housing made of plastic, rubber, or other suitable material.

The system provides great advantages over traditional bottles, jars, tubes, aerosols and pumps. The instant invention can be used for a variety of products and applications. In each case, the dispensing head/tip has been designed for the precise application of a particular viscosity and/or mix ratio of the ingredients. After use, the user can clean the dispensing head/tip and baffle chambers. Alternatively, after use, select components or the entire system of containers and components are disposable.

Some of the applications for the system are as follows: hair coloring, hair relaxers, permanent waves, epoxies, skin care products, automotive applications, gardening products, pharmaceutical dispensing, controlled dose inhalants, pet and veterinary formulations, personal grooming, and post-foaming products. Further objectives and advantages will become apparent from a consideration of the description, the drawings and examples.

### BRIEF DESCRIPTION OF THE DRAWINGS

The invention is better understood by reading the following detailed description with reference to the following figures in which like referencing numerals refer to like elements throughout, and in which:

FIG. 1 is a side view of an embodiment of the assembled invention;

FIG. 2 shows a front view of the assembled invention of FIG. 1;

FIG. 3 shows a perspective bottom view of the head of the assembled invention;

FIG. 4 shows a cross-sectional view of a cartridge in a head of the assembled invention; and

FIG. 5 shows a perspective top view of a collar of the assembled invention.

### DETAILED DESCRIPTION OF THE INVENTION

In describing an exemplary embodiment of the present invention illustrated in the drawings, specific terminology is employed for the sake of clarity. However, the invention is not intended to be limited to the specific terminology source selected. It is to be understood that each specific element includes all technical equivalents, which operate in a similar manner to accomplish a similar purpose. The term “a” is intended to mean at least one unless the context indicates otherwise.

A “container” may include any type of fluid containers, including aerosol containers of the piston type using a polyethylene, propylene, or a more sophisticated polymer barrier structure molded or thermoformed as a piston disposed between a propellant such as a hydrocarbon, compressed air (CAIR) or nitrogen, and a product to be dispensed. The containers may also be of the so-called bag-in-can type having an inner container such as a bag or pouch that attaches to either of the top seam of the can or the can curl. Generally, any other type of container, e.g., various non-aerosol types such as a contraction system of a previously-expanded bladder for dispensing, may be used with the device of the present invention. The type, size, shape and geometry of the container used in the exemplary embodiment disclosed herein are neither critical nor essential aspects of the invention.

A “cartridge” generally refers to a mixing chamber or body through which thorough mixing of constituents is performed such as, for example, a mixing chamber or a baffle chamber.

A “mixing canal” refers to a hollow through which constituents are passed and mixed and includes, for example, a tortuous or sinuous path, a channel, a mixing channel, and a baffle.

A “head” refers to an extension through which mixed constituents flow and includes, for example, a dispensing nozzle, an applicator, a comb with voids through which constituents flow.

A “column” or protrusion refers to a member within the mixing canal that interrupts the flow in the mixing canal to provide turbulent flow area while permitting flow around both (at least two) sides of the member. Prior art structures, such as fins mounted to the side of the mixing canal, passing material around only one side, are not intended to be encompassed within the meaning of column according to the invention.

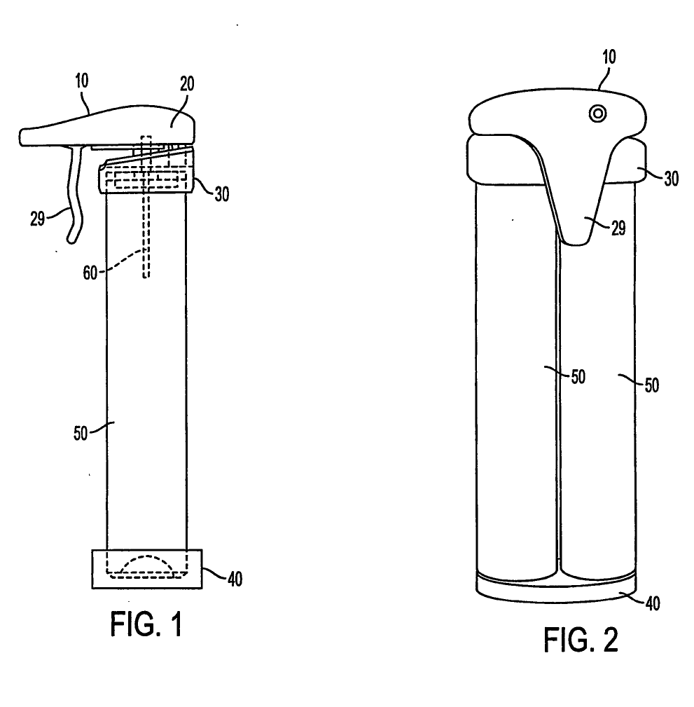

FIG. 1 is a side view of an embodiment of the assembled invention. The system of the depicted embodiment consists of the four basic components: a head/cap 10 having hinge hooks, a cartridge 20, a collar 30 having hinge-hook receptacles for connection with the hinge hooks, at least two aerosol containers 50, a base 40 that can fit onto the bottoms of the containers to secure them together, and aerosol tubes 60 for each creating an air passage between a respective container and a respective inlet port of the cartridge upon actuation of the system. When the head 10 is depressed, for example, by action on an optional lever 29 attached to the head 10 or depression of the head, valves on aerosol tubes 60 are depressed in turn to actuate release of constituents of the pressurized aerosol containers 50 via respective aerosol tubes 60. The released constituents are then mixed in a mixing chamber integrated on the cartridge 20 and are outputted at an outlet of the head 10. The components are coupled to one another, for example, in a snap-to-fit fashion or by a friction-fit method wherein the components may be disassembled, for example, without the use of tools. The aerosol tubes 60 may be employed when a conventional aerosol is used. The aerosol tubes 60 may be omitted when barrier-type or piston-type containers are used. Variations in the order and placement of the components are contemplated by the current invention.

The head 10 contains and integrally holds the cartridge 20. The head optionally includes a lever 29 or “j-hook” that may be depressed to actuate the release of components from containers 50 and may be integrated onto the head 10 or the cartridge 20. The head 10 is designed to be interchangeable with other heads or additional components by which the shape of the head is modified, allowing the shape to fit the application. For example, in hair care applications, an extension or attachment might be added to facilitate dispensing the hair care product through a comb- or brush-shaped applicator. Thus, a wide variety of applicators and attachments may be exchanged in place of a particular head 10 or may be attached to the head 10.

FIG. 2 shows a front view of the embodiment of the assemble invention in FIG. 1.

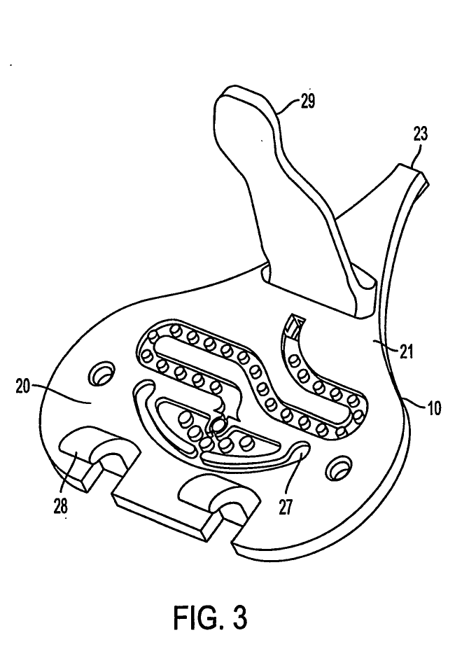

FIG. 3 shows a perspective bottom view of the head 10. The head 10 has hinge hooks 28 for coupling with the collar. The cartridge 20, for example, has a cover piece 21 to cover and complete the enclosure of pre-formed channels for flowing constituents to be mixed.

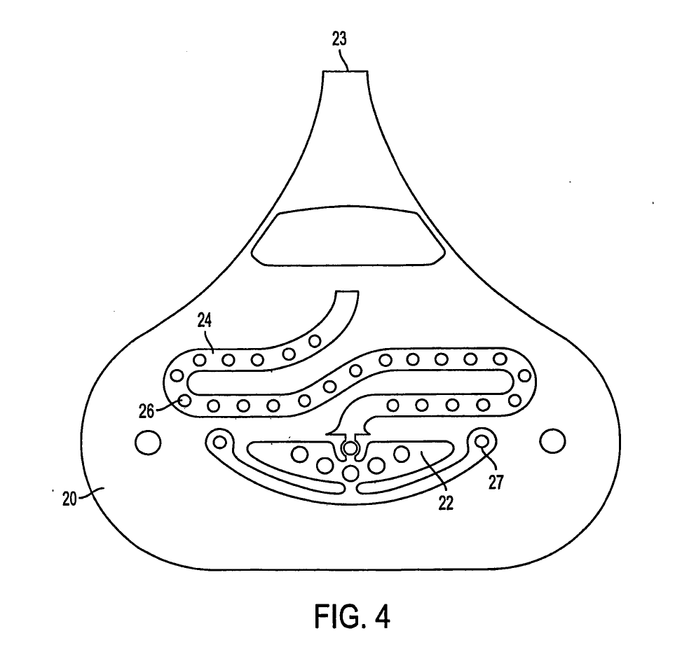

FIG. 4 shows a cross-sectional view of the cartridge 20. Referring to FIGS. 3 and 4, the head 10 integrally and/or internally holds the cartridge 20. One of ordinary skill in the art can appreciate that the cartridge may extend integrally or internally into additional components of the device as design needs dictate. Referring to FIG. 4, when constituents of the containers 50 are released upon actuation of the system, each constituent passes though a respective aerosol tube to a respective inlet port 27. The constituents then contact each other at a plenum 22 and are then transported together to a mixing canal 24. In the mixing canal 24, the constituents are thoroughly mixed as turbulence is created in the flow of the constituents by the operation of columns 26 on the constituents as they pass through the mixing canal 24 and encounter columns 26. Columns 26 are typically placed along the flow path in the mixing canal 24 and may also be placed in the plenum 22, at the junction of the plenum 22 and the mixing canal 24 or elsewhere, in the flow path of the constituents between the inlets 27 and outlet 23. The columns 26 can be cylindrical, rectangular, square, oval, triangular, fin-shaped, hexagonal and any other geometric shape. The thoroughly mixed constituents are then dispersed via an outlet port 23 which connects to the end of the mixing canal 24 distal to the plenum 22. The plenum 22, mixing canal 24, and strategically placed columns 26 within the mixing canal 24 continuously mix the separate constituents in the mixing canal 24. For example, the mixing canal 24 may be about 4.1″ long and about 0.12″ wide and about 0.04″ tall. The column height is about 0.04″ tall and 0.03″ in radius. The number of columns 26 in the mixing canal in the depicted embodiment is about 24, although fewer or more may be employed. A suitable number is about 3 to 12 per inch, for example about 6 per inch, of channel length. Thus the total column count for a 4″ channel could be about 12 to 48. The columns may be placed in the center between the column side walls where there will be about 0.03″ wide open space between the columns and either one of the sidewalls or may be offset to one or another side or both. It is appreciated by one of ordinary skill in the art that the dimensions of the mixing canal 24 and the columns 26 and the number of columns may be increased or decreased to suit the application, constrained only by the limitations of the overall size of the system and the cartridge 20 therein. For example, the columns may have a diameter of about 25% to about 75% of the channel width, e.g., of 50%, and a height of about 25% to about 75% of the channel height or 90% or even 100% of the height sufficient to cause thorough mixing. Likewise the columns may all rise from the bottom or hang from the top surface of the channel, or they may alternatively rise from the bottom and hang from the top approximately perpendicular.

The arrangement of columns 26 induces sufficient turbulence for thorough mixing of the constituents without producing excessive back pressure. The following column variables can be adjusted to affect the mixing and the back pressure of the system: height, spacing between columns, flexibility, material and surface smoothness.

The cartridge 20 is interchangeable and can be designed to match the characteristics of the constituents to be dispersed. For instance, different viscosity constituents, foams, and the like require various geometries and container pressures to provide thorough mixing within the mixing canal. In particular, the spacing and dimensions of the columns 26 and the length, width and height of the flow path may be varied to suit the particular constituents. Further, the container pressures may also be varied dependent upon the application and the physical properties of the constituents. The container pressures may be the same or different to allow 1:1 mixing ratio of the constituents of the containers or any other mixing ratios such as 2:1 or 3:1. The mixing ratios may also be affected by adjusting relative sizes of the inlet ports 27 or dimensions of the passage ways from the inlet ports 27 to the plenum 22.

The optional lever 29 may be attached to either the head 10 or the cartridge 20 to protrude downward. This lever 29 may be of any shape, for example, a “j-hook”, with a concave section for actuation with a finger. It is ergonomically designed to activate/actuate the release of the contents of the containers 50 and into the plenum 22 in the cartridge 20 upon activation. This trigger may be helpful, for example, in applying hair products as it permits one handed operation of the system during application of the fluid constituents. One can also press on the top of the head 10 and release the contents of the containers 50 through the inlets 27 into the plenum 22 of the cartridge. One of ordinary skill in the art will appreciate the additional methods of actuating the device can be achieved.

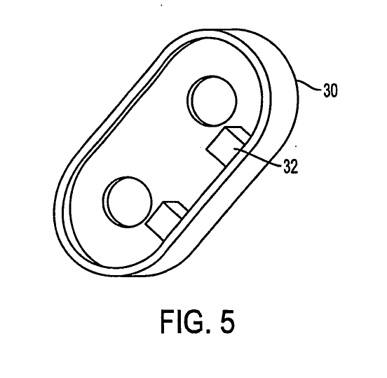

FIG. 5 shows a perspective top view of the collar 30 of the assembled invention. The collar 30 connects the head 10 and the cartridge 20 to the containers 50. The collar 30 holds the cartridge 20 on top by locking the hinge hooks of the head 10 or cartridge onto hinge-hook receptacles 32 of the collar 30 and the containers 50 on the bottom by using, for example, snap-fit or friction-fit areas formed thereat that are complementary in shape with respective areas of the containers. The collar 30 is designed to accept a range of container lengths and geometries that have the same head dimensions. The collar 30 has a plurality of openings to accommodate a plurality of containers and provide a secure communication of the contents of the containers to the cartridge. Additionally, the collar 30 can be integrally formed with the head 10 or the cartridge 20 or both.

Referring again to FIG. 1, the base 40 is shown to fit onto the bottom portions of the containers 50 to secure them in place. Alternatively, the base 40 may include an extended case that encloses the containers 50 and snaps into the underside of the collar 30. Still another embodiment is to have the extended case of the base 40 cover the entire lengths of the containers and not cover the bottom surfaces. When the base 40 having the extended case is used, the case is designed to match the approximate length and diameter of the containers 50. If the case is used, it can be provided with a rounded contour, for example, to fit comfortably in the hand of the user and may be plastic, rubber, shrink wrap or other material. A case may also fit into the collar 30 by using, for example, snap-fit tabs or friction-fit configurations. Means for adjusting the length of the base 40 to accommodate various lengths of containers 50 can be provided. Molded-in, raised ribs in either a soft or rigid material providing grip section (not shown) for the user on the exterior surface of a cover of the base 40 can be used on any of the designs. The base 40 is sized to hold a plurality of containers 50, for example, two containers.

An exemplary material for the production of the device is plastic. Metals, rubbers, ceramics, and any combinations thereof may be used to produce the device or any specific components of the device, depending on the application. Examples of plastic materials are polypropylene and polyethylene. Any suitable manufacturing process for all given material may be used to manufacture the device and its components. For example, plastic materials may be used to form the components by injection molding. If soft material is used for the raised ribs area on the base, they may be, for example, molded in polyurethane, silicone or a similar material. If the device is to be reusable, then snap-to-fit tabs may be overbuilt to be more durable and more accessible, as in conventional latching mechanisms.

The device is operated in the following manner with reference to the illustrated embodiment: the base 40 is fitted onto the bottom portions of the containers 50 by using snap-to-fit tabs or friction-fit configurations; the collar 30 is fitted onto the top portions of the containers 50 by using snap-to-fit tabs or friction-fit configurations after which aerosol tubes 60 will extrude out of the collar 30 via openings for the aerosol tubes 60; the cartridge 20 is fitted onto the head 10 by using snap-to-fit tabs or friction-fit configurations; the head 10 is then fitted onto the collar 30 by locking the hinge hooks of the head onto the hinge-hook receptacles of the collar 30. The device is now fully assembled and loaded with the necessary constituents. A case of the base 40 or, in the absence of a case, the containers themselves, is grasped, for example, from the side like a book binding. The lever 29 or the head 10 is depressed. Depression of the optional lever 29 or the head 10 then activates, either directly or indirectly, the actuators on the containers 50, so as to release constituents of the containers into the system. The constituents are then separately passed through inlets 27 and into the plenum 22 of the cartridge 20 where they are introduced to each other on their way into the mixing canal. Thorough mixing is achieved by the columns 26 arranged to interrupt the laminar flow of the constituents, providing points of turbulent flow in the mixing canal 24 which mix the constituents. The mixed constituents exit via the exit port as a thoroughly mixed homogeneous product.

### EXAMPLE 1

A specific example of this device is described below with reference to FIGS. 1-5. The device is used to mix two chemicals into a homogeneous mixture for application by the end user. The chemicals are stored in two gas-charged cylinders 50. When the device is actuated, the chemicals are released into the cartridge. The constituents first enter a plenum 22, which leads to a mixing canal 24. The mixing canal 24 is fitted with columns 26 that agitate the two chemicals into one homogenous mixture. The columns 26 are cylindrical in shape, for example, but can also be fin-shaped.

The mixing canal 24 is sized and shaped to comply with the physical parameters of the constituent chemicals to be mixed. In particular, the viscosity of constituents, the charge present in the cylinders 50, and the degree of mixing required, which in turn would relate to the dimensions of the mixing canal 24 and the number of columns 26, dictate the geometry of the mixing canal 24.

The adjustment of the viscosity of the two chemicals and the gas pressure in the cylinders provides approximately the same chemical flow rate from both gas cylinders 50 into the plenum 22. The parameters to be matched are generally related in the following manner. The higher the viscosity of the chemicals, the larger the gas charge needed to provide a net chemical flow through the plenum 22 and into the mixing canal 24. For example, the plenum 22 configuration is designed so that the path lengths between the two air cylinder input ports 27 and the common exit port 23 are identical. Both flows of chemicals should be met at the input ports 27 with the same flow rate and back pressure, for example, so that equal amounts of the two chemicals enter the mixing canal 24. Alternatively, by using different container pressures, input port sizes or dimensions of the passages ways from the input ports 27 to the plenum, different mixing ratios of the constituents can be achieved.

The height, radius and number of columns generally describe the geometry of the mixing canal 24. The geometry of the mixing canal 24 may be varied to provide a suitable degree of mixing at a usable flow rate for the end user. The larger the cross sectional height and width of the mixing canal 24, the higher the flow of rate. The larger the number of columns 26, the better the mixing and the longer the length of the mixing canal 24, the lower the flow rate. The larger the columns 26, the lower the flow rate. The greater density of the columns 26, the lower the flow rate.

The columns 26 in this example are cylindrical and are integrated with the cartridge, for example. The columns 26 can also be rectangular, square, oval, triangular, fin-shaped, hexagonal and any other geometric shapes. It is appreciated by those skilled in the art the thickness and height of the columns are variable to suit the particular space constraints, as mentioned above, or to suit the application of the device. The columns 26 in this example can extend completely through the height of the canal. Alternatively the columns 26 can extend partially in height through the canal.

In an example of manufacturing the necessary components, the head 10 can be formed in one piece and the cartridge 20 can be formed in two pieces. The head 10 may be formed into a thin plastic piece by injection-molding a polypropylene or polyethylene material into a head structure having a cavity at the bottom for receiving the cartridge 20. The cartridge 20 and the lever 29 is formed as one piece, for example, by injection-molding the lever and all of the structures of the integrated mixing chamber including the mixing canal 24, the columns 26, the plenum 22, input ports 27, and the exit port 23 on the cartridge. A cover piece 21 for covering the mixing canal 24, the columns 26, the plenum 22 and input ports 27 to seal their respective enclosed spaces can be injection-molded, for example, as a third plastic piece. The exit port 23 is to be formed as an embedded structure within the cartridge 20 and a cover for the exit port is not necessary. Then the cover piece 21 can be fitted onto the second piece by using, for example, glue-fit method, snap-to fit tabs, ultra-sonic attachment, or friction-fit configurations. In the glue-fit method, for example, the cover piece 21 is glue-fitted onto the second piece by applying enough pressure on the two pieces against each other to close any open space between their contact surfaces and form complete sealing contacts and may include gluing of the cover piece 21 to the cartridge 20. The joined structure of the cartridge 20 and the cover 21 is then, for example, fitted onto the head 10 by using, for example, glue-fit method, snap-to-fit tabs, ultra-sonic attachment, or friction-fit configurations. Alternatively, the cartridge 20 can be inserted into the head 10 first and then secondly the cover 21 can be fitted onto the cartridge 20. The same material or different materials may be used in injection-molding the three separate pieces.

The embodiments illustrated and discussed in the specification are intended only to teach those skilled in the art the best way known to the inventors to make and use the invention. Nothing in this specification should be considered as limiting the scope of the present invention. The above-described embodiments of the invention may be modified or verified, and elements added or omitted, without departing from the invention, as appreciated by those skilled in the art in light of the above teaching. It is therefore to be understood that, within the scope of the claims and their equivalents, the invention may be practiced otherwise than as specifically described.

1-30. (canceled)

31. A mixing system comprising:
two containers containing constituents;
a cartridge for accepting constituents from the containers and a mixing canal for mixing the constituents in said containers;
a head for holding said cartridge; and
a collar connecting said head and said cartridge to said containers.

32. The system of claim 31, wherein the head includes a lever to activate release of the constituents into the cartridge.

33. The system of claim 31, wherein the constituents of said containers are released by pressing on the top of said head.

34. The system of claim 31, wherein the mixing canal comprises a hollow through which the constituents are passed and mixed.

35. The system of claim 31, wherein said collar, said head and said cartridge are coupled by a snap-to-fit or friction-fit method.

36. The system of claim 31, further comprising an outlet port through which mixed constituents are dispensed.

37. The system of claim 31, wherein the head internally holds the cartridge.

38. The mixing system of claim 31, wherein
the collar is configured for coupling to the containers;
the cartridge further includes a plenum and an input, and an outlet that are connected to pass and mix the plurality of constituents upon release of the constituents from the containers;
the mixing canal including a plurality of columns for facilitating the mixing; and
upon activation, the plurality of constituents are released into the plenum and thereby mixed in the cartridge to provide a thoroughly mixed product comprised of the plurality of constituents.

39. The system of claim 38, wherein the columns are cylindrical, oval or fin-shaped.

40. The system of claim 31, further comprising a base configured for receiving the containers and securing the containers within the base.

41. A cartridge for mixing constituents comprising:
inputs for accepting a plurality of constituents;
a plenum in fluid communication with the inputs;
a mixing canal in fluid communication with the plenum and into which the constituents flow and are mixed; and
an outlet through which the mixed constituents pass.

42. The cartridge of claim 41, further comprising
a plurality of columns disposed within the mixing canal to promote turbulent flow as the constituents flow within the mixing canal.

43. The cartridge of claim 42, wherein the columns are cylindrical, oval or finshaped.

44. A method of mixing a plurality of constituents from pressurized containers comprising the steps of:
attaching a collar to the containers, wherein the collar connects a head that holds a cartridge having a plurality of inputs for accepting constituents from the containers and a mixing canal for mixing the constituents in said containers;
actuating a plurality of actuators on the containers to release the plurality of constituents;
separately passing each of the plurality of constituents through the cartridge, thereby thoroughly mixing the constituents; and
ejecting the thoroughly mixed constituents.

45. The method of claim 44, wherein the cartridge comprises a plurality of integrally molded columns; and
separately passing each of the plurality of constituents through the cartridge further comprises passing the plurality of constituents around the plurality of columns.

46. The method of claim 45, wherein the columns are cylindrical, oval or fin-shaped.

47. The method of claim 45, wherein
actuating a plurality of actuators on the containers comprises actuating a valve on each of said containers by pressing on the top of said head.

48. The method of claim 44, wherein the mixing canal comprises a hollow through which the constituents are passed and mixed.

49. The method of claim 44, wherein said collar, said head and said cartridge are coupled by a snap-to-fit or friction-fit method.

50. A mixing system comprising:
a) means for activating a plurality of actuators to release constituents from each of a plurality of containers;
b) separate means for thoroughly mixing the plurality of constituents, comprising a means for passing each of the plurality of constituents into the mixing means and means for ejecting the thoroughly mixed constituents;
c) separate means for attaching the activating means and the mixing means to the containers.
